(19) United States
(12) Patent Application Publication
(10) Pub. No.: US 2008/0217236 A1
(43) Pub. Date: Sep. 11, 2008

(54) Cartridge type oil filter and engine cleaning device

(75) Inventors: Takeshi Shimizu, Ehime (JP); Makoto Okawa, Aichi (JP); Masaru Takechi, Yamanashi (JP)

Correspondence Address: HAMRE, SCHUMANN, MUELLER & LARSON, P.C., P.O. BOX 2902, MINNEAPOLIS, MN, 55402-0902, US

(73) Assignee: JAPAN CERAMIC DEVICE CO., LTD., Ehime (JP)

(21) Appl. No.: 11/899,409

(22) Filed: Sep. 5, 2007

(30) Foreign Application Priority Data
Sep. 5, 2006 (JP) 2006-240141
Jul. 9, 2007 (JP) 2007-005257

(51) Int. Cl. B01D 27/00

(52) U.S. Cl. 210/335

(57) ABSTRACT

The present invention provides a cartridge type oil filter including a case having a container section and a cover section that are integrated with each other; a filter element housed in the case; and ceramics bodies disposed at a position separated from an oil filtration surface of the filter element in the case.

### BACKGROUND OF THE INVENTION

1. Field of the Invention

The present invention relates to cartridge type oil filters that are mounted to engine blocks and are disposed on oil flow passages for supplying engine oil to respective sections. The present invention also relates to engine cleaning devices that eliminate carbon sludge adhering to engines.

2. Related Background Art

In conventionally known cartridge type oil filters, containers and covers are integral with each other to compose cases for housing filter elements. In such filters, the cases and all should be replaced to replace the oil filters. Measures occasionally are taken in order to repress the deterioration in engine performance by using such cartridge type oil filters.

For example, JP 2005-9378 A discloses a deterioration reduction device that is externally mounted to a cartridge type oil filter. This deterioration reduction device separates water from engine oil using a ceramics product for decomposing moisture in engine oil, and maintains the viscosity of oil.

Concretely, the deterioration reduction device is mounted to an oil filter by using an oil outlet provided on a cover of the foil filter as a threaded hole, and has an approximately disc-shaped main body disposed between the cover and an engine block. A circular groove is formed on a position of a cover surface in the main body corresponding to an inlet provided to the cover, and the groove houses the ceramics product. Further, JP2005-9378 A discloses, as the ceramics product, a ceramic product obtained by firing a raw material composed of fine particles of dacite and clay at 1200° C. to 1300° C.

However, a number of components should be installed in the proper order in order that the deterioration reduction device intervenes between the cartridge type oil filter and the engine block. As a result, the installation operation is complicated, and there is a high risk of oil leaking due to the large number of components.

Since the ceramics product is held not to the cartridge type oil filter but to the main body of the deterioration reduction device, when the filter element is replaced, only the oil filter is replaced but the ceramics product can be left unreplaced. If the ceramics product is left for a long time, the deterioration (deterioration due to adhesion of an oil component or the like) of the ceramics product might progress due to engine oil, and also the surface of the ceramics product is peeled and the peeled pieces might be mixed in the engine oil. Even when the peeled pieces are caught by the filter element, the effective surface area of the filter element is reduced.

In the deterioration reduction device having the above structure, since the ceramics product housed in the groove is exposed before the main body is installed to the oil filter, the ceramics product might be damaged during transportation and at the time of installation. In order to prevent this damage, a ceramics product having high strength should be used in the deterioration reduction device. For this reason, the ceramics products are strengthened by firing at high temperature of 1200° C. to 1300° C. In the case of such high-temperature firing, however, the production cost of the ceramics products is high, and further in the case of two-stage firing composed of biscuit firing and firing described in JP 2005-9378 A, the production cost is particularly high.

### SUMMARY OF THE INVENTION

In view of such a circumstance, it is an object of the present invention to provide a cartridge type oil filter in which ceramics bodies can be disposed in an oil flow passage inexpensively without causing an increase in the number of components, and the ceramics bodies are not left unreplaced. It is another object of the present invention to provide an engine cleaning device which is capable of eliminating carbon sludge caused by fuel adherent to an engine without performing an engine cleaning operation known as flushing.

In order to achieve the above object, the present invention provides a cartridge type oil filter including: a case including a container section and a cover section integrated with each other; a filter element housed in the case; and ceramics bodies disposed at a position that is separated from an oil filtration surface of the filter element and in the case.

From another aspect, the present invention provides an engine cleaning device including: a case including a container section and a cover section integrated with each other; a filter element housed in the case; and ceramics bodies disposed at a position that is separated from an oil filtration surface of the filter element and in the case. In the engine cleaning device, each of the ceramics bodies includes tourmaline and silicate containing an alkaline component. The cover section has an oil inlet and an oil outlet, a flow passage that connects the oil inlet and the oil outlet via the filter element is formed in the case, and the ceramics bodies are disposed on an upper stream side of the filter element so as to come in contact with oil flowing through the flow passage. In the engine cleaning device, carbon sludge adherent to the engine is reduced or the adhesion of carbon sludge to the engine is prevented by circulation of the oil in a state of the device being arranged so as to have the oil used for lubrication of the engine passed through the flow passage.

According to the cartridge type oil filter of the present invention, since the ceramics bodies are disposed in the case, the ceramics bodies can be arranged on the oil flow passage only by installing the oil filter to an engine block or the like. As a result, the number of components to be installed does not increase. Therefore, there is not a high risk of the oil leaking. When the filter element is replaced, the case and all are replaced, so that the ceramics bodies are not left unreplaced. Further, since the ceramics bodies are protected by the case, biscuit-firing ceramics bodies having low strength can be used.

According to the engine cleaning device of the present invention, carbon sludge can be removed or adhesion of carbon sludge can be prevented only by installing the oil filter to the engine block or the like.

### BRIEF DESCRIPTION OF THE DRAWINGS

FIG. 1 is a schematic block diagram illustrating an engine having a cartridge type oil filter according to one embodiment of the present invention;

FIG. 2 is a cross-sectional view illustrating the cartridge type oil filter;

FIG. 3 is a perspective view illustrating a supporting member that supports a filter element;

FIGS. 4A and 4B are photographs illustrating the interior of a cylinder head of an engine, FIG. 4A illustrates a state after a conventional oil filter is mounted and a running test is conducted, and FIG. 4B illustrates a state after the oil filter is replaced with an oil filter according to one embodiment of the present invention and a running test is conducted; and

FIGS. 5A and 5B are photographs illustrating the interior of the cylinder head of the engine, FIG. 5A illustrates a state after the conventional oil filter is mounted and the running test is conducted, and FIG. 5B illustrates a state after the oil filter is replaced with an oil filter according to one embodiment of the present invention and the running test is conducted.

### DETAILED DESCRIPTION OF THE INVENTION

The best mode for carrying out the present invention is described in detail below with reference to the drawings.

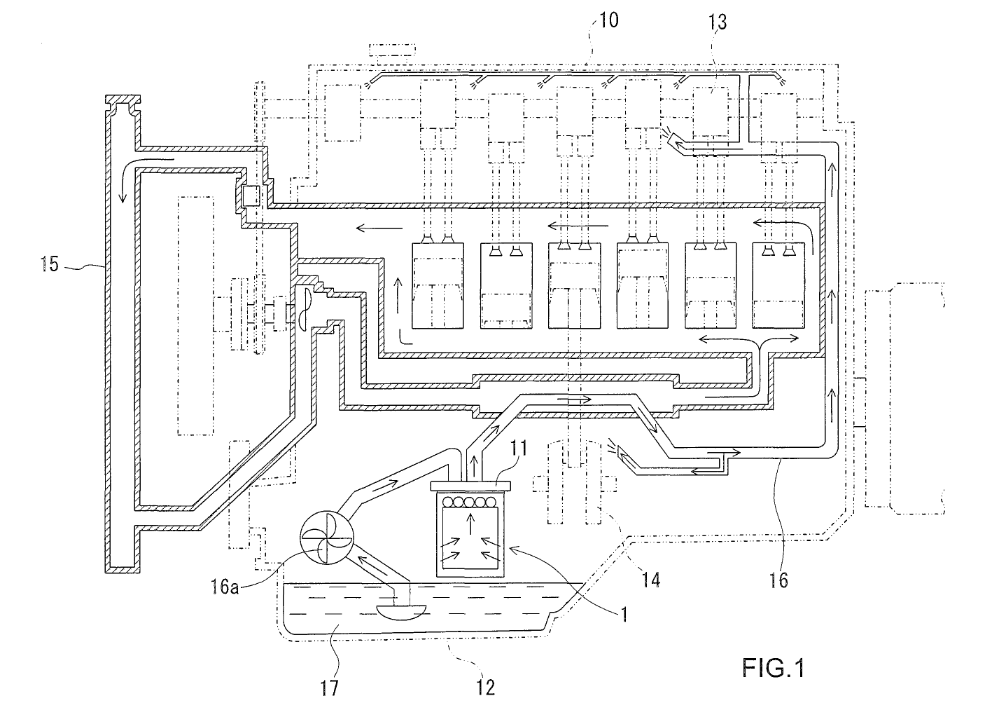

As shown in FIG. 1, a cartridge type oil filter 1 according to one embodiment of the present invention filters engine oil 17 to be used for lubrication of a cam shaft 13 and a crank shaft 14 in an engine 10. The engine oil 17 is held in an oil pan 12, and is supplied therefrom to respective sections via an oil flow passage 16. The engine oil 17 is pumped up by an oil pump 16a and is cooled by a cooling system 15 in the oil flow passage 16. The cartridge type oil filter 1 is mounted to an engine block 11 so as to be arranged at some point in the oil flow passage 16.

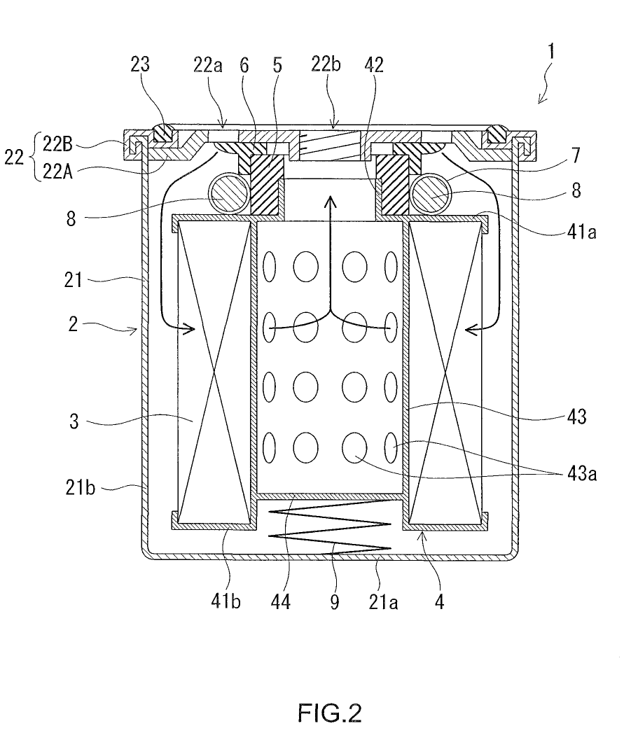

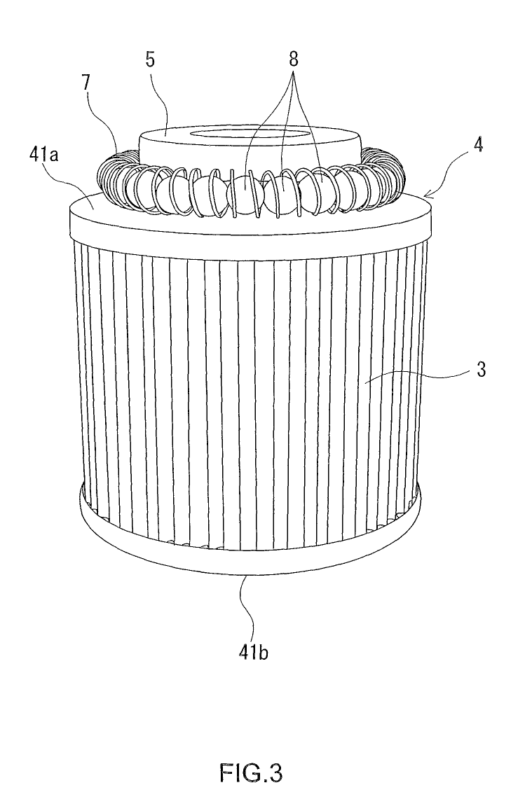

As shown concretely in FIGS. 2 and 3, the cartridge type oil filter 1 includes a case 2 that has container section 21 and a cover section 22 integrated with each other, a filter element 3 housed in the case 2, and a supporting member 4 that supports the filter element 3 in the case 2. In this specification, for convenience of the explanation, an upper side of FIG. 2 is identified as upside, and a lower side is identified as downside.

The container section 21 has a cylindrical wall section 21b that extends in an up-down direction, and a bottom section 21a that blocks a lower part of a space surrounded by the wall section 21b. On the other hand, the cover section 22 opposed to the bottom section 21a of the container section 21 in the up-down direction is composed of an approximately disc-shaped base section 22A, and a ring section 22B fixed to a peripheral edge portion on an upper surface of the base section 22A. The ring section 22B of the cover section 22 is fixed to the upper end portion of the wall section 21b of the container section 21 by caulking or the like, so that the cover section 22 is integrated with the container section 21.

More specifically, an oil outlet 22b structured by a threaded hole is provided to a center portion of the base section 22A of the cover section 22, and a plurality of oil inlets 22a are provided around the oil outlet 22b so as to be spaced equally on the periphery of the cover section 22. A seal member 23 that seals between the cover section 22 and the engine block 11 is held to the ring section 22B.

The filter element 3 is folded up into concertinas in order to increase a filtration area, and is supported by the supporting member 4 with its oil filtration surface facing outward to form a cylindrical shape. A spacer 5 and a check valve 6 are disposed between the supporting member 4 and the cover section 22, and they block between the supporting member 4 and the cover section 22. As a result, as shown by an arrow in FIG. 2, a flow passage that reaches from the oil inlets 22a to the oil outlet 22b via the filter element 3 is formed.

The supporting member 4 has an oil recovery section 43, a pair of clamping pieces 41a and 41, and a leading-out pipe 42. The filter element 3 is wound around an outer peripheral surface of the oil recovery section 43 which has a cylindrical shape extending to the up-down direction, and the oil recovery section 43 recovers the engine oil 17 passing through the filter element 3 from a lot of oil circulation ports 43a. The clamping pieces 41a and 41b support the filter element 3 wound around the oil recovery section 43 from the side of the cover section 22 and from the side of the bottom section 21a of the container 21 respectively. The leading-out pipe 42 protrudes upward from the upper clamping piece 41a towards the cover section 22 and leads the engine oil 17 recovered by the oil recovery section 43 to the oil outlet 22b. A reactive force plate 44, which receives a biasing force of a compression coil spring 9 for biasing the supporting member 4 upward, is provided at a lower part of the oil recovery section 43. A relief valve, not shown, which secures a flow rate at the time of clogging of the filter element 3 is provided on the reactive force plate 44.

The spacer 5 is made of, for example, rubber, and has a circular shape, and is fitted at the outside of the leading-out pipe 42 of the supporting member 4. The check valve 6, which prevents backflow of the engine oil 17 from the oil inlets 22a, is mounted to the upper end of the spacer 5.

The circular spring 7, which holds a plurality of biscuit-firing ceramics bodies 8 arranged in a circular path, is fitted at the outside of the spacer 5 lower than the check valve 6. As a result, the ceramics bodies 8 are arranged on an upper-stream side of the filter element 3 in the case 2, more specifically, on the position between the filter element 3 and the cover section 22, further more specifically, between the clamping piece 41a of the supporting member 4 and the check valve 6. That is to say, an arrangement space for the ceramics bodies 8 is secured between the supporting member 4 and the cover section 22 by the spacer 5. This brings the engine oil 17 flowing through the flow passage into contact with the ceramics bodies 8 before the engine oil 17 reaches the filter element 3. When the ceramics bodies 8 are disposed so as to be separated from the oil filtration surface of the filter element 3 in such a manner, the effective filtration area of the filter element 3 is not reduced by the ceramics bodies 8.

Each of the ceramics bodies 8 has a spherical shape. A diameter of each ceramics body 8 is preferably about 4 to 8 mm. The contact area of the ceramics bodies 8 with respect to the engine oil 17 is increased by decreasing their diameters and thereby increasing the number of the ceramics bodies 8. As a result, the ceramics bodies 8 easily influence the engine oil 17. It is difficult to arrange the ceramics bodies 8 having too large diameter in the case 2, and it is difficult to manufacture and fix the ceramics bodies 8 having too small a diameter.

Any ceramics can be used as the ceramics bodies 8 without particular limitation as long as they can modify the engine oil 17 through adsorption of components of the engine oil 17 and elution of the components to the engine 20 oil 17. For example, as the ceramics bodies 8, ceramics bodies that produce the following function can be used.

a) Oil, water and the like that come in contact with the ceramics surfaces are induced in an alkaline direction (preferably, induced to about pH 8.3).

b) An interfacial activity effect is produced in liquid that comes in contact with the ceramics surfaces. As described later, it appears that this effect contributes to a cleaning effect of the engine 10.

c) An oxidation-reduction potential is reduced to about 150 mV.

In the cartridge type oil filter 1 of this embodiment, since the ceramics bodies 8 are disposed in the case 2, the ceramics bodies 8 can be disposed in the oil flow passage 16 only by mounting the oil filter 1 to the engine block 11. As a result, the number of components to be mounted is not increased. Therefore, there is not a high risk of oil leaking. Since the case 2 with the ceramics bodies 8 and all can be replaced at the time of replacing the filter element 3, the ceramics bodies 8 are not left unreplaced. Considering the deterioration in the ceramics bodies 8 and further their breakage due to the deterioration, from viewpoints of the persistent expression of the effect due to the ceramics bodies 8 and engine protection, it is very important to replace the ceramics bodies 8 periodically.

Since the ceramics bodies 8 are protected by the case 2, the biscuit-fired ceramics bodies 8 can be used. Although the biscuit-fired ceramics bodies 8 have lower strength than that of biscuit and hardened-fired ceramics bodies, the production facilities for the biscuit-fired ceramics bodies are simple due to a low heating temperature, and thus the biscuit-fired ceramics bodies 8 can be produced at very low cost. For this reason, the use of the biscuit-fired ceramics bodies 8 can realize the arrangement of the ceramics bodies 8 in the oil flow passage 16 at low cost.

The biscuit firing (su-yaki) is firing that is carried out at temperature of about 700° C. to 950° C. and removes crystal water and organic substances in a green body to improve a water-absorbing property and mechanical strength. On the contrary, the firing carried out at higher temperature in order to harden the green body is called as the biscuit and hardened-firing.

Since the biscuit-fired ceramics bodies 8 are porous microscopically, oil easily penetrates the ceramics bodies 8. On the contrary, in the case where a raw material is fired at high temperature of about 1300° C., depending on the composition of the raw material, the raw material partially melts to form a glassy surface layer frequently. As a result, oil cannot penetrate to interior. That is to say, when the biscuit-fired ceramics bodies 8 are used, the engine oil 17 penetrates the ceramics bodies 8, and large contact surface and long contact time of the ceramics bodies 8 with respect to the engine oil 17 can be secured, thereby making the effect produced by the ceramics bodies 8 more apparent.

It might be considered that ceramics powder is carried on the filter element 3, but this not only reduces the effective filtration area of the filter element 3 but also easily breaks the filter element 3 due to the presence of foreign matters (powder). In the case where the filter element 3 is broken, the ceramics powder is at risk of flowing out through the oil outlet 22b. On the contrary, when the ceramics bodies 8 having a certain size (for example, diameter: not less than 4 mm) are arranged on the upper stream side of the filter element 3 as in this embodiment, the above risk does not arise.

Since the ceramics bodies 8 are arranged on the position between the filter element 3 and the cover section 22, the engine oil 17 from the oil inlets 22a can be brought into contact with the ceramics bodies 8 immediately.

Further, since the check valve 6 is arranged on the upper stream side of the ceramics bodies 8, even if the surfaces of the ceramics bodies 8 are peeled, the peeled pieces are prevented from being discharged from the oil inlets 22a.

Since the spacer 5 that secures the arrangement spaces for the ceramics bodies 8 is fitted at the outside of the leading-out pipe 42, the spacer 5 can be mounted easily at the time of producing the oil filter 1.

The ceramics bodies 8, for example, may be fastened to the clamping piece 41a of the supporting plate 4 or may be embedded into the outer peripheral surface of the spacer 5 without being held by the spring 7. Not the plurality of ceramics bodies 8 but one circular ceramics body 8 may be provided. However, when the plurality of ceramics bodies 8 are held by using the spring 7, the large contact surface of the ceramics bodies 8 with respect to the engine oil 17 can be secured.

A preferable composition of the ceramics bodies 8 is described below.

The ceramics body preferably contains tourmaline, and more preferably contains silicate including an alkaline component that is not tourmaline.

According to an experiment by the inventors, it is confirmed that when the ceramics bodies including tourmaline are used, an engine cleaning effect described in the following example can be produced. A detail of the reason why the ceramics bodies produce the cleaning effect is not clear at the present time. Taking into consideration the fact that carbon sludge that adheres to the engine is eliminated, the most likely reason is that a component that produces the surface activating function in the engine oil is generated continuously due to the contact with the ceramics bodies including tourmaline. Although a surface active agent is added to the engine oil, carbon sludge that adheres to the engine cannot be eliminated by the surface active agent originally included in the oil. It is considered to be important for cleaning the engine to supply continuously a component that produces surface activating function to the oil or to supply a component having stronger detergent power for carbon sludge than that of the originally included surface active agent in the engine oil.

It is confirmed that when the ceramics bodies containing tourmaline are used, the fuel consumption of automobiles is improved. The cleaning of the engine and the Toms effect due to the presence of a trace amount of the component for providing the surface activating function are likely to contribute to the improvement of the fuel consumption.

Tourmaline is a hexagonal crystal having a composition expressed by (Ca, K, Na) (Al, Fe, Li, Mg, Mn)₃(Al, Cr, Fe, V)₆(O, H, F)₄(BO₃)₃(Si₆O₁₈). It is known that tourmaline, also called an “electric stone” exhibits weak piezoelectricity and pyroelectricity. The surface charges of tourmaline might be a reaction point of a chemical reaction to change the oil components. It can be assumed that alkaline components in tourmaline (K, Na) produce the surface activating function in the oil component. According to the experiment by the inventors, however, the amount of the alkaline components in tourmaline is considered insufficient for maximally exerting the surface activating function of the oil components. Some kinds of tourmaline do not contain alkaline components. Therefore, the ceramics body should be produced from a raw material including silicate containing an alkaline component together with tourmaline. The preferable content of the alkaline component in the ceramics body is not less than 3% in terms of oxide weight. When silicate containing an alkaline component was used together with tourmaline as the ceramics body, the fuel consumption of automobiles further was improved in comparison with the case of using tourmaline alone. Silicate containing an alkaline component can be used without particular limitation as long as it includes an alkali metal element such as K or Na. Within the confirmation from some experiments, components of silicate (for example, silica and alumina) excluding an alkaline component hardly contribute to the engine cleaning.

### EXAMPLE

The tests, which were conducted in order to confirm the effect of the cartridge type oil filter 1 of the above embodiment using the ceramics bodies 8 containing tourmaline, are described below.

### (Cleaning Effect Confirmation Test)

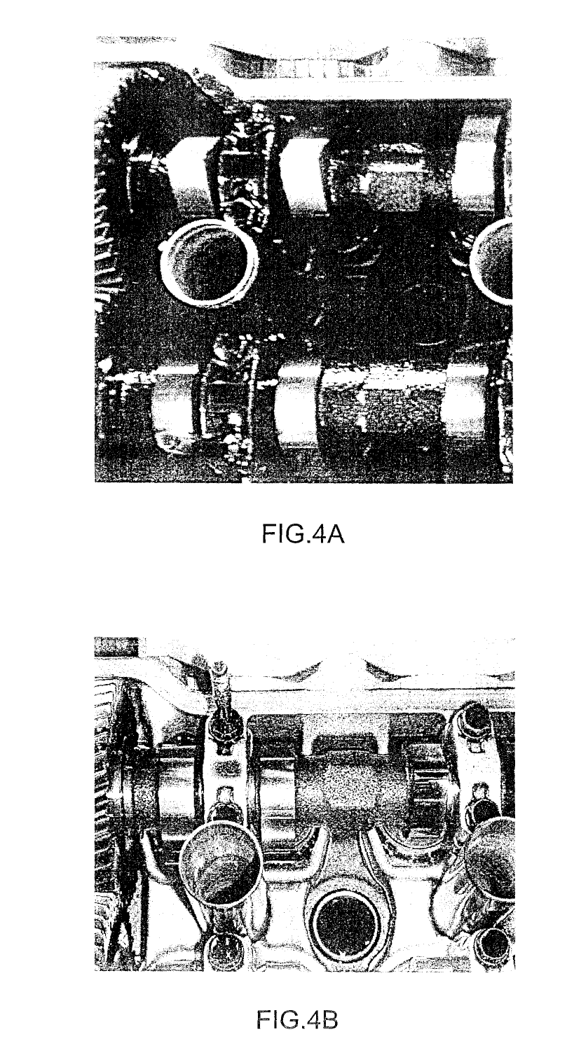

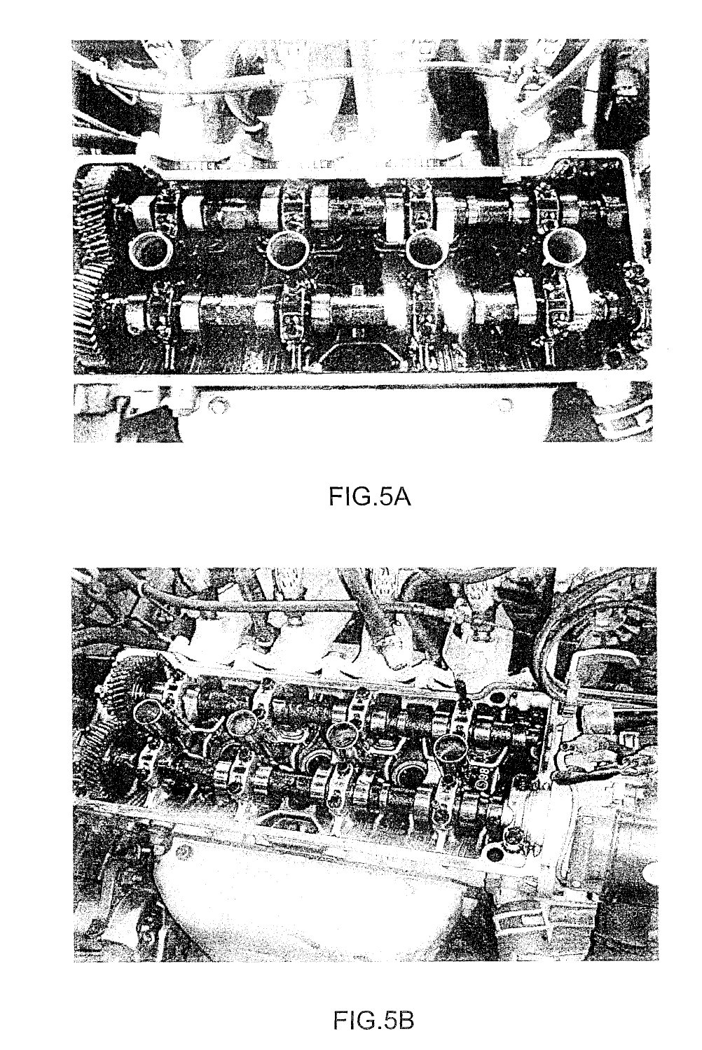

A conventional cartridge type oil filter which is not provided with ceramics bodies was installed in a Toyota Corolla produced by Toyota Motors and the car was driven. The interior of a cylinder head of the engine was photographed at the time when the car traveled 93000 km. The photographs are shown in FIGS. 4A and 5A.

The conventional cartridge type oil filter was replaced with the cartridge type oil filter 1, the car further was driven 5000 km, and the interior of the cylinder head of the engine was photographed. The photographs are shown in FIGS. 4B and 5B.

The ceramics bodies 8 used here were obtained by biscuit-firing a ceramics raw material which is regulated so as to contain about 30 wt % of tourmaline and silicate including an alkaline component as the remainder at 850° C. to 900° C. This ceramics raw material contains 1.16 wt % of K₂O and 2.64 wt % of Na₂O according to X-ray fluorescence analysis.

After the car to which the conventional cartridge type oil filter was installed was driven, carbon sludge adhered to the inside of the engine 10. However, after the conventional filter was replaced with the cartridge type oil filter 1 of the embodiment and the car was driven, carbon sludge was eliminated and the metal surface was exposed clearly. The inside of the engine 10 was cleaned up more thoroughly than flushing.

When the cartridge type oil filter 1 of the embodiment is disposed on the oil flow passage 16, it works as an engine cleaning device that can clean the inside of the engine 10 through the circulation of the engine oil 17.

### (Fuel Consumption Improvement Confirmation Test)

10-15 mode fuel consumption of the Primera produced by Nissan Motor Co., Ltd. at the time when the Primera was driven about 4200 m was measured by a chassis dynamometer (VST-3600-4 W produced by Banzai Ltd.) in the cases where the conventional cartridge type oil filter was installed thereto and the cartridge type oil filter 1 of the embodiment (the ceramics bodies are the same as those used in the above test) was installed thereto. The measurement was taken three times in each case, and average values were calculated.

In the case where the conventional cartridge type oil filter was installed, the fuel consumption was 12.72 km/L, but in the case where the cartridge type oil filter of the embodiment was installed, the fuel consumption was improved to 13.11 km/L.

What is claimed is:

1. A cartridge type oil filter comprising:
a case comprising a container section and a cover section, the container section and the cover section being integrated with each other;
a filter element housed in the case; and
ceramics bodies disposed at a position that is separated from an oil filtration surface of the filter element and in the case.

2. The cartridge type oil filter according to claim 1, wherein the ceramics bodies are biscuit-firing ceramics bodies.

3. The cartridge type oil filter according to claim 1, wherein each of the ceramics bodies includes tourmaline.

4. The cartridge type oil filter according to claim 3, wherein each of the ceramics bodies further includes silicate containing an alkaline component.

5. The cartridge type oil filter according to claim 1, wherein the cover section has an oil inlet and an oil outlet, a flow passage that reaches from the oil inlet to the oil outlet via the filter element is formed in the case, and the ceramics bodies are arranged on an upper stream side of the filter element so as to come in contact with oil flowing through the flow passage.

6. The cartridge type oil filter according to claim 5, wherein the ceramics bodies are arranged at a position between the filter element and the cover section.

7. The cartridge type oil filter according to claim 6, further comprising a check valve disposed between the cover section and the ceramics bodies, the check value preventing backflow of the oil from the oil inlet.

8. The cartridge type oil filter according to claim 6, further comprising:
a supporting member that is disposed in the case, the supporting member having a pair of clamping pieces for supporting the filter element from the side of the cover section and from a bottom side of the container section; and
a spacer provided between the supporting member and the cover section, the spacer securing an arrangement space for the ceramics bodies.

9. The cartridge type oil filter according to claim 8, wherein
the supporting member has a leading-out pipe, and
the leading-out pipe protrudes from a clamping piece that is one of the clamping pieces and arranged on the cover section side towards the cover section and leads the oil that has passed through the filter element to the oil outlet, and
the spacer has a circular shape and is fitted at the outside of the leading-out pipe.

10. The cartridge type oil filter according to claim 9, wherein a circular spring is fitted at the outside of the spacer, and the ceramics bodies are held by the circular spring.

11. The cartridge type oil filter according to claim 1, wherein each of the ceramics bodies is a spherical object having a diameter of 4 to 8 mm.

12. An engine cleaning device comprising:
a case comprising a container section and a cover section, the container section and the cover section being integrated with each other;
a filter element housed in the case; and
ceramics bodies disposed at a position that is separated from an oil filtration surface of the filter element and in the case,
wherein each of the ceramics body includes tourmaline and silicate containing an alkaline component, and
the cover section has an oil inlet and an oil outlet, a flow passage that reaches from the oil inlet to the oil outlet via the filter element is formed in the case, and the ceramics bodies are disposed on an upper stream side of the filter element so as to come in contact with oil flowing through the flow passage, and
carbon sludge adhering to an engine is reduced or carbon sludge is prevented from adhering to the engine by circulation of the oil in a state that the device being arranged so as to have oil to be used for lubrication of the engine passed through the flow passage.

13. The engine cleaning device according to claim 12, wherein the ceramics bodies are biscuit-firing ceramics bodies.

14. The engine cleaning device according to claim 12, wherein the ceramics bodies are arranged at a position between the filter element and the cover section.

15. The engine cleaning device according to claim 14, further comprising a check valve disposed between the cover section and the ceramics bodies, the check value preventing backflow of the oil from the oil inlets.

16. The engine cleaning device according to claim 14, further comprising:
a supporting member disposed in the cases, the supporting member having a pair of clamping pieces for supporting the fitter element from the side of the cover section and from a bottom side of the container section; and
a spacer provided between the supporting member and the cover section, the spacer securing an arrangement space for the ceramics bodies.

17. The engine cleaning device according to claim 16, wherein
the supporting member has a leading-out pipe, and
the leading-out pipe protrudes from a clamping piece that is one of the clamping pieces and arranged on the cover section side towards the cover section and leads the oil passing through the filter element to the oil outlet, and
the spacer has a circular shape and is fitted at the outside of the leading-out pipe.

18. The engine cleaning device according to claim 17, wherein a circular spring is fitted at the outside of the spacer, and the ceramics bodies are held by the circular spring.

19. The engine cleaning device according to claim 12, wherein each of the ceramics body is a spherical object having a diameter of 4 to 8 mm.
